(19) United States
(12) Patent Application Publication
(10) Pub. No.: US 2022/0100203 A1
(43) Pub. Date: Mar. 31, 2022

(54) METHOD FOR THE CONTROL, BY A SUPERVISING SERVER, OF THE MOVEMENT OF A FLEET OF AUTONOMOUSLY GUIDED VEHICLES

(71) Applicant: Balyo, Ivry-Sur-Seine (FR)

(72) Inventors: Thomas Orvane, Paris (FR); Guillaume Voisin, Noisy-Le-Grand (FR)

(21) Appl. No.: 17/420,655

(22) PCT Filed: Jan. 6, 2020
(86) PCT No.: PCT/FR2020/050007

§ 371 Date: Jul. 2, 2021

(30) Foreign Application Priority Data
Jan. 4, 2019 (FR) 1900075

(51) Int. Cl. G05D 1/02; H04W 36/32; G08G 1/127; G06F 16/13

(52) U.S. Cl. CPC G05D 1/0291; H04W 36/32; H04W 84/12; G05D 1/0276; G06F 16/13; G08G 1/127

(57) ABSTRACT

A method for the control, by a supervising server, of the movement of a fleet of autonomously guided vehicles in a movement area equipped with a plurality of wireless access points each comprising at least one geolocation means and a Wi-Fi communication module, the method comprising a step of recording coordinates of these access points and steps of changing the access point, which are executed by each of the autonomously guided vehicles, the steps consisting of controlling the disconnection of the Wi-Fi communication module from the active access point and reconnection to the SSIDᵢ access point for which the coordinates recorded in the database are the closest of the coordinates determined by the geolocation means.

### CROSS-REFERENCE TO RELATED APPLICATIONS

This application is a national phase entry under 35 U.S.C. § 371 of International Patent Application PCT/FR2020/050007, filed Jan. 6, 2020, designating the United States of America and published as International Patent Publication WO 2020/141287 A1 on Jul. 9, 2020, which claims the benefit under Article 8 of the Patent Cooperation Treaty to French Patent Application Serial No. 1900075, filed Jan. 4, 2019.

### TECHNICAL FIELD

The present disclosure relates to the field of automatic guided vehicles (AGV) that move autonomously without human intervention, in particular, in warehouses to perform handling using geoguidance technology.

### BACKGROUND

European patent EP3219663 describes an example of the mechanical structure of such an automated guided vehicle.

Geoguidance is based on the recognition of fixed elements inside a building—walls, columns and racks—to allow the automated guided vehicles to find their way in real time. This flexible system allows the chosen solution to be quickly and economically reconfigured if necessary. The system allows the AGVs to find their way autonomously in the working environment and automatically calculate their paths. Using this technology, the vehicles are aware of their position constantly and very precisely. The map of the environment in which the automated guided vehicle moves may be modified very easily, which makes this technology very flexible. To coordinate the movement of a plurality automated guided vehicles on the same site, a supervisor controls the segregation of trajectories to avoid collisions.

The present disclosure relates more particularly to the control of the movement of automated guided handling vehicles by a supervising server controlling, in particular, the segregation of the trajectories of a fleet of autonomously guided vehicles by periodically transmitting digital information via a Wi-Fi radiofrequency network. The supervising server connects in real time with the warehouse management environment (ERP, WMS, machines, doors, conveyors, traceability) and is easily incorporated in existing industrial and logistical processes.

Solutions for managing a fleet of automated guided vehicles developed by Kiva Systems, which became Amazon Robotics, are known in the prior art.

International patent application WO2017165873A1 describes a method for queuing robots destined for a target location in an environment, which includes the steps of determining if a first robot occupies the target location and if it is determined that the first robot occupies the target location, determining if a second robot destined for the target location has entered a predefined target zone proximate the target location. If the second robot has entered the predefined target zone, the method further includes the steps of navigating the second robot to a first queue location and causing the second robot to wait at the first queue location until the first robot no longer occupies the target location. The method also includes the step of navigating the second robot to the target location after the first robot leaves the target location.

European patent application EP2044494 describes another example of a method for moving one or more mobile drive units within a workspace and includes receiving, from a first mobile drive unit, a reservation request requesting use of a first path segment to move in a first direction. The method further includes the step of determining that a second mobile drive unit is currently located on the first path segment and determining whether the second mobile drive unit is moving in the first direction. Additionally, the method includes the step of transmitting a reservation response indicating that the reservation request is denied, in response to the step of determining that the second mobile drive unit is not moving in the first direction. The method also includes the step of transmitting a reservation response indicating that the reservation request is granted, in response to the step determining that the second mobile drive unit is moving in the first direction.

Another solution for managing a fleet of autonomous devices is described in European patent EP0618523B1. This method allowing control of the transport of a plurality of unmanned vehicles moving along travel routes made up of a plurality of connection routes connecting the nodes that form vehicle stopping positions comprises:
a first operation consisting of searching for an optimal travel route, which connects a current node to a target node, with a minimal cost for each unmanned vehicle, by calculating the travel costs for possible transport intervals connecting the current node and the target node on the basis of the distance or travel time between the nodes, and the angular difference between the direction of each node when two adjacent nodes forming the travel route are seen from the target node of the unmanned vehicle;
a second operation consisting of finding, among a plurality of optimal travel routes obtained in the course of operation 1, opposite direction intervals forming travel routes that have mutually opposed directions;
a third operation consisting of stopping the processing if opposite direction intervals are not present and, if opposite direction intervals are present, calculating in that case a total cost for each unmanned vehicle by totaling the costs of the opposite direction intervals present in the travel route of each unmanned vehicle;
a fourth operation consisting of applying a specified direction to an opposite direction interval on the travel route of the unmanned vehicle that has the highest total cost, so that this interval has a particular direction; and
a fifth operation consisting of determining the optimal travel routes of all the unmanned vehicles again, with the above-mentioned application of a specified direction to the travel routes;
wherein the optimal travel routes with no conflict are determined by repeating operations 2 to 5 until there are no more opposite direction intervals in operation 2, the processing being terminated at operation 3.

European patent EP2036014 relates to a method for moving a mobile drive unit within a workspace that includes receiving a path. The path includes at least an initial segment and one or more additional segments. The initial segment includes a portion of the path adjacent to the first point; and at least one of the additional segments includes a portion of the path adjacent to the second point. The method further includes storing the path, reserving the initial segment of the path, and moving away from the first point along the initial segment. After initiating movement along the initial segment, the method includes reserving each of the additional segments of the path and moving toward the second point along each of the additional segments while that segment is reserved.

U.S. Ser. No. 10/017,322 relates to a solution where self-guided vehicles communicate wirelessly with the central computer system and are controlled entirely or for the most part by the central computer system. In some of the embodiments described, the central computer system is configured to control the movement of motorized transport units through the product storage installation based on a variety of entries.

For example, the central computer system communicates with each motorized transport unit via the network, which may be one or more wireless networks or a plurality of wireless networks (such as a local wireless network, a local wireless network, a wireless mesh network, a wireless star network, a wireless wide area network, a cellular network, etc.), capable of providing wireless coverage for the range required by the motorized transport units using any known wireless protocol, including but not limited to a cellular, Wi-Fi, ZIGBEE® or BLUETOOTH® network.

Chinese patent CN107864210 describes a remote monitoring system for a forklift truck. The system comprises: a forklift truck controller; a main control module in communicating connection with the control module that obtains forklift status information via the forklift controller, generates a message according to the forklift status information and sends the message; a server that is in communicating connection with the main control module, receives the message from the main control module, analyzes the message and stores the message in a database; and a mobile terminal that is in communicating connection with the server and monitors the forklift in real time. The remote monitoring system of the forklift, provided by the present disclosure, obtains the forklift status information via the forklift controller, generates the message from the forklift status information using the main control module and sends the message to the server. The maintenance personnel establish a connection with the server through the mobile terminal for monitoring the forklift truck in real time.

These solutions of the prior art require reliable radiofrequency communication between each of the automated guided vehicle and the supervising server to ensure constant transmission of information from each of the vehicles to the supervising server and the period sending, at a high frequency, of movement or stop instructions by the supervising server to each of the automated guided vehicles.

In vast operating spaces, such as large warehouses, radiofrequency coverage is provided by a plurality of Wi-Fi access points spread over the area concerned. This requires the intercellular transfer or handover to be managed by each autonomous device. Handover is not part of the basic 802.11 Wi-Fi standards specification, and different methods, both proprietary and generic, are proposed. The Wi-Fi module usually scans the frequencies used for the Wi-Fi standard periodically to identify the available access points and record their ISDN and signal quality and, if the signal is lost, controls a connection sequence with the access point that has the best signal quality from the list of access points identified during the scanning operation. This solution is not well suited to automated guided vehicle fleet management applications as the scanning time may be some seconds, which is not compatible with the need for continuous connection with the supervising server.

In the prior art, a solution described in U.S. Pat. No. 7,466,986B2 has also been proposed, intended for equipment that has Wi-Fi functionality and GPS access point location functionality. This device detects the Wi-Fi access points (hotspots) and updates a locally-stored database of geographically-mapped hotspots.

If a hotspot is detected, the device accesses it, retrieves identification information and conditions of use and measures the performance metrics thereof.

The device stores the hotspot identified with the GPS coordinates in the form of a database entry.

When the user later desires to locate hotpots within a particular geographic location, the user enters the physical address of the location and hotspots with coordinates that match the GPS coordinates (or are close thereto) are then presented to the user. The user may specify certain preferences for the conditions of use, performance metrics and location criteria desired, the utility filters all geographic hits and returns only hotspots in the geographic location that also satisfies these preferences. When a hotspot is detected, the utility triggers the user device to access the hotspot and retrieves information about the particular hotspot, including the name and performance metrics, such as quality of service (QoS) and connection speed. The utility then obtains the current GPS location and associates the identified hotspot with the current GPS coordinate. Then, the utility stores the hotspot ID and parameters along with the current GPS coordinates as an entry within the hotspot location database (HLD).

This solution only partly responds to the problem of automatic guided vehicle fleet management by a supervisor connected via a Wi-Fi network.

The solution proposed by U.S. Pat. No. 7,466,986B2 is not about roaming, but occasional access by a laptop computer to a Wi-Fi access point. In these circumstances, the connection process may take some hundreds of milliseconds or even a few seconds with no real inconvenience.

The solutions in the prior art have the drawback of periods with no signal resulting from the handover time from an access point with insufficient signal quality to another access point identified as optimal.

The latency results from the delay relating to the protocol for opening a radio channel and authenticating the device on the new access point. This may also be a relatively long period of some tens of milliseconds to a few seconds if there is a fault in the authentication procedure.

These delays are very detrimental, as during this time either the device goes into safety stop mode or continues to move according to the latest recorded information, which is not updated during the delay.

For solutions where digital files are transmitted by Wi-Fi, the connection time is not very sensitive as the data can be buffered to ensure an uninterrupted flow. However, when communicating safety instructions, writing to a buffer memory is not suitable as the data change quickly and the available data may be obsolete.

Furthermore in a warehouse, GPS satellite geolocation is not always possible as the metal environment of a warehouse may perturb the synchronized electromagnetic signals transmitted by the satellites.

### BRIEF SUMMARY

To overcome this drawback, the present disclosure relates in the most general sense to a method for the control, by a supervising server, of the movement of a fleet of autonomously guided vehicles in a movement area equipped with a plurality of wireless Wi-Fi access points each comprising at least one geolocation means and a Wi-Fi communication module, the method comprising a step of recording the coordinates of these access points and steps of changing the access point, which are executed by each of the autonomously guided vehicles, the steps consisting of controlling the disconnection of the Wi-Fi communication module from the active access point and reconnection to the SSIDᵢ access point for which the coordinates recorded in the database are the closest of the coordinates determined by the geolocation means, wherein the geolocation means for the autonomously guided vehicles comprise means of measuring the relative movement of the vehicle in relation to a plurality of physical reference elements in the movement area, and in that the reconnection step also comprises controlling the reconnection to the nearest second SSIDᵢ₊₁ access point:
if the authentication delay of the communication module with the SSIDᵢ access point exceeds a predetermined period Tₐᵤₜ;
and/or if the response period of the server to a ping transmitted by the communication module with the SSD, access point exceeds a predetermined period T_{ping};
the method comprising controlling the safety stopping of the vehicle if the reconnection delay exceeds a period T_{safety}.

Advantageously, the step of recording the coordinates of the access points comprises moving a map acquisition vehicle between a plurality of geolocation points in the work area and controlling, while the vehicle is immobilized at an acquisition point, the recording of the geographic coordinates and the identifiers of the Wi-Fi access points detected, then controlling the movement to a new acquisition point, to form a digital geolocation map of the access points, the digital map being recorded in the local memory of each of the autonomously guided vehicles.

According to a variant, the method also comprises a step of recording access points that are absent from the digital map and the coordinates thereof by at least some of the autonomously guided vehicles, and periodically transferring the data to the supervising server.

Preferably, the movement of the autonomously guided vehicle is controlled according to data received from the supervising server, which data are buffered during the roaming sequences.

In a variant, the processor of the autonomously guided vehicle controls the safety stopping of the movement if the predetermined roaming delay is exceeded.

### BRIEF DESCRIPTION OF THE DRAWINGS

The present disclosure will be better understood on reading the detailed description of a non-limited example of the present disclosure that follows, with reference to the accompanying drawing in which:

FIG. 1 is a diagrammatic view of a warehouse equipped for the circulation of autonomous handling vehicles.

### DETAILED DESCRIPTION

Computer Architecture

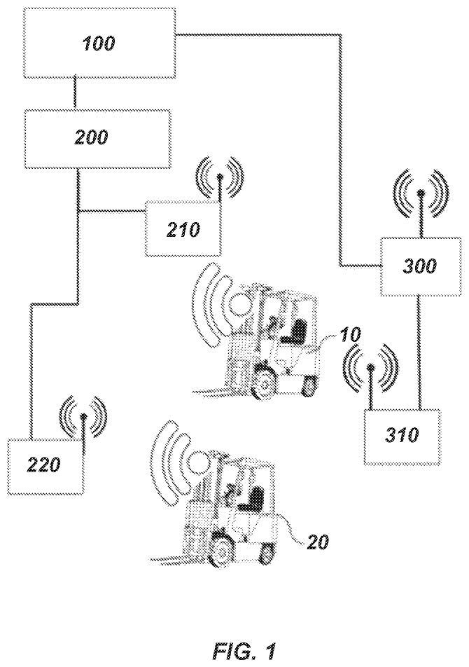

FIG. 1 is a diagrammatic view of a warehouse equipped for the circulation of autonomous handling vehicles (10, 20) under the supervision of a server (100), which will not be described in greater detail in the present patent disclosure as the server corresponds to supervising servers of the prior art.

Wireless communication between the server (100) and each of the autonomous handling vehicles (10, 20) is based on IEEE radioelectric network standard 802.11 and amendments thereto usually known collectively as Wi-Fi or wireless fidelity.

Accordingly, the server (100) is connected to an MU-MIMO router (200) and access points (210, 220) forming a community Wi-Fi network. The Wi-Fi access points (210, 220) have different parameters, one of which allows the radio network to be identified, and is known to persons skilled in the art by the abbreviation SSID (service set identifier). The community Wi-Fi network has the particular feature of using the same SSID_Com for all the domestic gateways intervening in the network.

The community network is not specific to the present disclosure but corresponds to pre-existing communication infrastructure in the warehouse where the present disclosure is implemented. The access points (210, 220) comprise, for example, repeaters implanted at different points in the warehouse to ensure good Wi-Fi network accessibility.

Optionally, Wi-Fi coverage may be provided by independent access points comprising a router (300) and one or more access points (310) that have another SSID_ext identifier.

The autonomous handling vehicles (10, 20) are each equipped with a Wi-Fi communication module and one or more autonomous geolocation means that are independent of any external technical infrastructure, in particular, independent of the GPS system or a system of radio-transmission beacons to allow total autonomy in positioning the handling vehicle.

The geolocation means are made up of:
LiDAR for acquiring environment data for the vehicle (10, 20); the LiDAR is connected to the movement measurement of the vehicle by an inertial measurement unit with synchronization and geometric calibration; and
incremental positioning systems using the dead reckoning method, which comprises deducing the current position from the last known position. The vehicle (10, 20) is equipped with inertia sensors (accelerometers, odometers, gyroscopes, compass, etc.). These different devices allow movements in space to be quantified. This data allows the position to be determined by mapping onto the plan of the warehouse. The acceleration data collected during the movement phase then allows new positions to be determined. Positioning is relative, with the position at the point in time T-1 allowing that at the point in time T to be determined.

Management of the Fleet of Vehicles (10, 20)

The fleet of vehicles (10, 20) is managed by the supervisor by sending periodic digital messages, a plurality of times a second, which contain service information on the movement to be performed, depending on data originating upstream of the supervising server (100) of a warehouse management system (WMS) for managing the operations of a storage depot. Depending on the transport task and priority, conveyance orders are classified in an optimal order and conveyance orders are transmitted to the appropriate vehicles (10, 20).

In warehouses with narrow aisles, where the vehicles (10, 20) cannot pass each other, rules such as an exclusive circulation right must be coordinated. This means that the supervising server (100) gives a vehicle (10, 20) the exclusive use of an aisle in a warehouse for executing a conveyance task. At the same time, no other vehicle is sent to this aisle.

Messages relating to this service information are constantly recalculated by the supervising server (100), at a frequency of about 10 times a second and are then transmitted in the form of digital messages to each of the vehicles (10, 20).

Moving over vast expanses, the vehicles may often pass from the coverage area of one access point to another, and the object of the present disclosure is to reduce as far as possible the latency time that arises when switching from one access point to another. Even if each vehicle (10, 20) can buffer the information received from the supervising server (100) to ensure continuous operation during the access point handover phase, the data recorded quickly loses relevance as the data changes constantly and the buffered data quickly becomes obsolete.

Accordingly, the present disclosure provides for a roaming mode that is not based on constant scanning of the standard Wi-Fi radio band to passively detect nearby access points in real time, nor on an active search by probing the channels of the radio band and issuing a probe request. The present disclosure provides for the step of detecting the access points to be dissociated from the connection step, by the initial recording of a table of available geolocated access points.

Mapping Access Points

Accordingly, the present disclosure provides for a preliminary step of mapping the accessible access points (210, 220, 300, 310, etc.) in the work area of the vehicles (10, 20). This step may be repeated regularly to update the map. The step comprises moving a map acquisition vehicle equipped with a Wi-Fi module from point to point in all parts of the warehouse. If the map acquisition vehicle is immobilized at a point Pᵢ, an onboard processor on the map acquisition vehicle controls the recording in memory of the coordinates [xᵢ; yᵢ] of the vehicle as well as the discovery of the detectable access points. This discovery is effected either by passive listening while scanning the radio band to detect one or more nearby access points, or by actively searching by probing the channels of the radio band by issuing a probe request. In the first case, the station may subsequently issue a probe request addressed to the access point detected using the SSID of that access point to obtain additional information not broadcast by the beacon. The SSID access point responds with a probe response indicating the transmission capacities of the gateway taking account, in particular, of the number of users already connected to the gateway. In the second case, the access point, if there is one, responds with a probe response.

For each of the access points identified at point Pᵢ, the processor controls the recording of information, particularly the SSID, and possibly other information such as the quality of service and/or the communication protocol.

The map acquisition vehicle is then moved to the next point, and the operation is repeated until the entire work area is covered.

All the readings are then processed to construct a digital map associating with each neighboring area, defined by a set of coordinates, longitudes and latitudes that define a surface a priority access point and optionally a ranked list of secondary access points.

The digital map is recorded on the supervising server (100) and in the memory of each of the autonomous handling vehicles (10, 20).

Connecting a Vehicle (10, 20) to an Access Point

Connecting an autonomous handling vehicle (10, 20) to an access point comprises a first step of searching the local digital map for a priority access point corresponding to the immediate location of the vehicle (10, 20).

The Wi-Fi module of the vehicle (10, 20) issues a probe request addressed to the priority access point using the SSID of that access point to obtain additional information not broadcast in the beacon. The access point SSID responds with a probe response indicating the transmission capacities of the gateway taking account, in particular, of the number of users already connected to the gateway. In the second case, the access point, if there is one, responds with a probe response.

In a second step, the Wi-Fi module of the vehicle (10, 20) and the access point identify each other, followed by an association step that is necessary for the supervising server (100) to be able to send data via the access point.

If the step of authenticating the communication module with the access point ISDᵢ exceeds a determined period Tₐᵤₜ, the processor of the vehicle (10, 20) controls the initiation of a new connection step to the secondary access point in the ranked list corresponding to the immediate coordinates of the vehicle.

If the authentication step ends within a period less than the predetermined period Tₐᵤₜ, the processor of the vehicle (10, 20) controls the issuing of a ping by the Wi-Fi module. If the response period of the server to a ping transmitted by the communication module with the access point ISDᵢ exceeds a predetermined period T_{ping}, the processor of the vehicle (10, 20) controls the initiation of a new connection step to the secondary access point in the ranked list corresponding to the immediate coordinates of the vehicle.

If the reconnection time exceeds a period T_{safety} the processor of the vehicle (10, 20) controls the safety stopping of the vehicle.

WPA Protocol

For 802.1x authentication by WPA key negotiation (802.1x), the processor uses the EAP counters, for example, particularly the EAP-Identity-Request Timeout counter. This counter allocates the waiting period between EAP identity requests, according to a parameter of between 1 and 120.

By default, the waiting period is thirty seconds to take account of the fact that some equipment, wireless terminals, telephones, scanners, etc., have difficulty responding quickly enough.

In the present disclosure, the period is set at less than a second.

When initiating the connection procedure, the Wi-Fi module of the vehicle (10, 20) sends an EAPOL Start message to the access point associated with the location of the vehicle, and the access point sends an EAP packet, requesting the identity of the user or the machine. If there is no reply, the processor of the vehicle (10, 20) initiates a new connection procedure with the next access point.

Optionally, the EAP-Identity-Request Max Retries counter may also be used. The Max Retries value is the number of times the Wi-Fi module sends the identification request to the access point before deleting its entry in the MSCB. Once this value has been reached, the Wi-Fi module sends a deauthentication probe request to the access point, controlling the re-initiation of a reconnection procedure to the access point that has the next ISDN identifier in the recorded digital map list. The recommended value for the Max Retries option is between 1 and 3.

Optionally, the EAPOL-Key Timeout counter may also be used. For the timeout value of the EAPOL key, the routing established according to the present disclosure is between 200 and 1000 milliseconds. This means that if the EAPOL keys are switched between the access point and the Wi-Fi module, the access point sends the key and waits for the response from the client for a maximum of a second. Once the timeout value has been defined, the access point retransmits the key. If not, the processor controls reinitiation of a reconnection procedure to the access point with the next ISDN identifier in the recorded digital map list.

Optionally, the EAPOL-Key Max Retries counter may also be used. The EAPOL-Key Max Retries value is set at between 0 and 3; preferably at 1. This means that the original key request attempt will be sent N times to the client. If the access point does not respond, the processor controls reinitiation of a reconnection procedure to the access point with the next ISDN identifier in the recorded digital map list.

1.-5. (canceled)

6. A method of controlling, by a supervising server, movement of a fleet of autonomously guided vehicles in a movement area equipped with a plurality of wireless Wi-Fi access points, each of the guided vehicles comprising at least one geolocation device and a Wi-Fi communication module, the geolocation device comprising means for measuring movement of the vehicle relative to a plurality of physical reference elements in the movement area, the method comprising:
recording coordinates of the access points in a database;
causing at least one guided vehicle of the fleet to change the access point to which the guided vehicle is respectively communicatively coupled by disconnecting the Wi-Fi communication module of the at least one guided vehicle from an active access point and at least attempting to reconnect the Wi-Fi communication module of the at least one guided vehicle to a first nearest SSIDᵢ access point for which the coordinates recorded in a database are the closest of the coordinates determined by the geolocation device; and
causing the at least one guided vehicle to at least attempt to reconnect to a second nearest second SSIDᵢ₊₁ access point:
if an authentication delay of the communication module with the first nearest SSIDᵢ access point exceeds a predetermined period Tₐᵤₜ; and/or
if a response period of the supervising server to a ping transmitted by the communication module with the first nearest SSIDᵢ access point exceeds a predetermined period T_{ping}; and
safely stopping the at least one guided vehicle if a reconnection delay exceeds a period T_{afety}.

7. The method of claim 6, wherein recording coordinates of the access points in the database comprises moving a map acquisition vehicle between a plurality of geolocation points in the work area and controlling, while the map acquisition vehicle is immobilized at an acquisition point, the recording of the geographic coordinates and the identifiers of the access points detected, and then controlling movement of the map acquisition vehicle to a new acquisition point, and forming a digital geolocation map of the access points, and wherein the method further comprises recording the digital geolocation map in local memory of each of the autonomously guided vehicles.

8. The method of claim 7, further comprising recording data relating to access points that are absent from the digital geolocation map and the coordinates thereof by at least some of the autonomously guided vehicles, and periodically transferring the data to the supervising server.

9. The method of claim 6, wherein the movement of the autonomously guided vehicles is controlled according to data received from the supervising server, which data is buffered during movement of the autonomously guided vehicles.

10. The method of claim 6, wherein a processor of each of the autonomously guided vehicles is configured to safely stop movement of the respective autonomously guided vehicle if a predetermined roaming delay is exceeded.
